(19) United States
(12) Patent Application Publication
(10) Pub. No.: US 2018/0077645 A1
(43) Pub. Date: Mar. 15, 2018

(54) INFORMATION PROCESSING METHOD, BASE STATION, AND TERMINAL

(71) Applicant: Lenovo (Beijing) Co. LTD., Beijing (CN)

(72) Inventor: Zhi Yan, Beijing (CN)

(21) Appl. No.: 15/565,665

(22) PCT Filed: Sep. 9, 2015
(86) PCT No.: PCT/CN2015/089268

§ 371 Date: Oct. 10, 2017

(30) Foreign Application Priority Data
Apr. 10, 2015 (CN) 201510171200.8

(51) Int. Cl. H04W 52/02; H04W 74/08; H04W 74/00; H04W 4/00

(52) U.S. Cl. CPC H04W 52/0219; H04W 52/0216; H04W 4/005; H04W 74/006; H04W 74/0833

(57) ABSTRACT

The disclosure provides an information processing method, a base station, and a terminal. The method applied to a base station comprises: receiving a random access request transmitted by each terminal; determining a repeat rank of each terminal; in response to the random access request, determining, based on the repeat rank, a transmission parameter for transmitting a random access response data packet to each terminal; and transmitting, based on the transmission parameter for the random access response data packet, the random access response data packet.

### TECHNICAL FIELD

The present disclosure relates to the field of communication, and more particularly, to an information processing method, a base station, and a terminal.

### BACKGROUND

As for mobile communication technologies, before data communication performed, a terminal needs to connect to a base station with random access process and wait for the related communication resource allocated. The base station received the random access request will send response to the terminal to indicate the resources for set up the connection.

With the development of communication technology and electronic technology, type of terminals with communication ability is enriched, specifically, for instance, besides regular ordinary user terminal, there is Machine Type Communication (MTC) terminal. Further, radio communication environment also becomes increasingly complex, which results in the different terminal's efficiency of receiving signals when the signals are transmitted by the base station in different locations of the cell or in different application scenarios.

In order to reduce the cost for the random access response, a plurality of terminals will be multiplexed on the same random access response data packet to transmit the random access response, but the following two situations may occur:

First: the ordinary terminal and the MTC terminal are multiplexed on the same random access response data packet, wherein the ordinary terminal has better reception efficiency and usually can decode the random access response data packet correctly by one time receiving, whereas the MTC terminal may need to receive and merge and then decode correctly by multiple transmission of the data packet, however, the base station needs to repeatedly transmit the data packet multiple times to ensure that each terminal can receive the random access response correctly, this may result in that the ordinary terminal repeatedly receives and decodes the data packet, which causes waste of resource, or the MTC terminal incapable of receiving or decoding correctly.

Second: reception efficiency of the terminal in different communication scenarios in a cell are not consistent, usually, which may also result in that the ordinary terminal and the MTC terminal have different reception results for the same random access response data packet, or that the base station needs to transmit multiple times or some terminals cannot receive or decode normally. Specifically, for instance, terminals in different locations of a cell have inconsistent reception efficiency for the signals transmitted by the base station.

### SUMMARY

Embodiments of the present disclosure provide an information processing method, a base station, and a terminal.

The technical solutions of the present disclosure are implemented as below.

A first aspect of the present disclosure provides an information processing method applied to a base station, the method comprising:

receiving a random access request transmitted by each terminal;

determining a repeat rank of each terminal;

in response to the random access request, determining, based on the repeat rank, a transmission parameter for transmitting a random access response data packet to each terminal; and

transmitting, based on the transmission parameter for the random access response data packet, the random access response data packet.

Optionally, determining, based on the repeat rank, a transmission parameter for transmitting a random access response data packet to each terminal comprises:

determining, based on the repeat rank, a random access radio network temporary identity of each terminal, wherein a different repeat rank corresponds to a different random access radio network temporary identity; and

determining, based on the random access radio network temporary identify, a number of terminals that are multiplexed on the same access recess response data packet and a packet length of the random access response data packet.

Optionally, determining, based on the repeat rank, a random access radio network temporary identity of each terminal comprises:

determining a time-frequency resource location of the received random access request transmitted by each terminal, and

determining, based on the time-frequency resource location and the repeat rank, the random access radio network temporary identity of each terminal, wherein a different time-frequency resource location or a different repeat rank corresponds to a different random access radio network temporary identity.

Optionally, determining, based on the random access radio network temporary identify, a number of terminals that are multiplexed on the same access recess response data packet and a packet length of the random access response data packet comprises;

determining, based on the random access radio network temporary identity, a terminal number S of terminals that have the same random access radio network temporary identity, wherein terminals that have the same random access radio network temporary identity are multiplexed on the same random access response data packet; and

determining, based on the terminal number S, the packet length of the random access response data packet.

Optionally, determining, based on the terminal number S, the packet length of the random access response data packet comprises:

comparing the terminal number S with a multiplexed terminal number in a finite set T of the multiplexed terminal number, forming a comparison result;

selecting, based on the comparison result, a packet length having a correspondence with a multiplexed terminal number M as the packet length of the random access response data packet, wherein M is a multiplexed terminal number that is not less than S and has a minimum difference with S within T.

Optionally, the method further comprises:

if S is less than M, writing designated information into (S+1)-th to M-th random access responses of the random access response data packet.

Optionally, determining a repeat rank of each terminal comprises:

determining, based on a transmission parameter of the random access request and/or random access information carried in the random access request, a repeat rank of each terminal.

A second aspect of the present disclosure provides an information processing method applied to a first terminal, the method comprising:

transmitting, by the first terminal, a random access request to a base station;

determining a repeat rank of the first terminal;

forming, based on the repeat rank, a descrambling sequence; and

acquiring, based on the descrambling sequence, a random access response in a random access response data packet transmitted by the base station based on the random access request,

wherein the random access response data packet includes at least one random access response.

Optionally, forming, based on the repeat rank, a descrambling sequence comprises:

determining, based on the repeat rank, a random access radio network temporary identity of the first terminal; and

forming, based on the random access radio network temporary identity, the descrambling sequence.

Optionally, determining, based on the repeat rank, a random access radio network temporary identity of the first terminal comprises:

determining a time-frequency resource location at which the random access request is transmitted; and

determining, based on the time-frequency resource location and the repeat rank, the random access radio network temporary identity of each terminal, wherein a different time-frequency resource location or a different repeat rank corresponds to a different random access radio network temporary identity.

Optionally, acquiring, based on the descrambling sequence, a random access response in a random access response data packet transmitted by the base station based on the random access request comprises:

descrambling, based on the descrambling sequence, downlink control information;

acquiring, based on the downlink control information, a reception parameter for the random access response data packet transmitted by the base station, wherein the reception parameter includes at least one of time-frequency resource and a modulation encoding strategy; and

receiving, based on the reception parameter, the random access response data packet, and acquiring the random access response included in the random access response data packet.

Optionally, the downlink control information further includes a number of multiplexed terminals of the random access response data packet;

acquiring the random access response included in the random access response data packet comprises:

decoding, based on the multiplexed terminal number of the random access response data packet, the random access response data packet, to acquire the random access response.

Optionally, acquiring, based on the descrambling sequence, a random access response in a random access response data packet transmitted by the base station based on the random access request comprises:

decoding, based on a packet length to which each multiplexed terminal number in a finite set T of the multiplexed terminal number and the descrambling sequence, and receiving the random access response data packet, respectively;

when being decoded correctly, acquiring the random access response included in the random access response data packet transmitted by the base station.

Optionally, determining a repeat rank of the first terminal comprises:

carrying out a channel measurement, to form a channel measurement result; and

determining, based on the channel measurement result, the repeat rank.

Optionally, transmitting, by the first terminal, a random access request to a base station comprises:

determining, based on the repeat rank, a transmission parameter of the random access request and/or random access information.

A third aspect of the present disclosure provides a base station, comprising:

a first receiving unit for receiving a random access request transmitted by each terminal;

a first determining unit for determining a repeat rank of each terminal;

a second determining unit for, in response to the random access request, determining, based on the repeat rank, a transmission parameter for transmitting a random access response data packet to each terminal; and

a first transmitting unit for transmitting, based on the transmission parameter for the random access response data packet, the random access response data packet.

Optionally, the second determining unit comprises:

a first determining module for determining, based on the repeat rank, a random access radio network temporary identity of each terminal, wherein a different repeat rank corresponds to a different random access radio network temporary identity; and

a second determining module for determining, based on the random access radio network temporary identify, a number of terminals that are multiplexed on the same access recess response data packet and a packet length of the random access response data packet.

Optionally, the first determining module is specifically for determining a time-frequency resource location of the received random access request transmitted by each terminal; and determining, based on the time-frequency resource location and the repeat rank, the random access radio network temporary identity of each terminal, wherein a different time-frequency resource location or a different repeat rank corresponds to a different random access radio network temporary identity.

Optionally, the second determining module is specifically for determining, based on the random access radio network temporary identity, a terminal number S of terminals that have the same random access radio network temporary identity, wherein terminals that have the same random access radio network temporary identity are multiplexed on the same random access response data packet; and determining, based on the terminal number S, the packet length of the random access response data packet.

Optionally, the second determining module is specifically for comparing the terminal number S with a multiplexed terminal number in a finite set T of the multiplexed terminal number, forming a comparison result; and selecting, based on the comparison result, a packet length having a correspondence with a multiplexed terminal number M as the packet length of the random access response data packet, wherein M is a multiplexed terminal number that is not less than S and has a minimum difference with S within T.

Optionally, the base station further comprises:

a writing unit for, if S is less than M, writing designated information into (S+1)-th to M-th random access responses of the random access response data packet.

Optionally, the first determining unit is specifically for determining, based on a transmission parameter of the random access request and/or random access information carried in the random access request, a repeat rank of each terminal.

A fourth aspect of the present disclosure provides a terminal, which is a first terminal comprising.

a second transmitting unit for transmitting a random access request to a base station;

a third determining unit for determining a repeat rank of the first terminal;

a forming unit for forming, based on the repeat rank, a descrambling sequence; and

an acquiring unit for acquiring, based on the descrambling sequence, a random access response in a random access response data packet transmitted by the base station based on the random access request,

wherein the random access response data packet includes at least one random access response.

Optionally, the forming unit is specifically for determining, based on the repeat rank, a random access radio network temporary identity of the first terminal; and forming, based on the random access radio network temporary identity, the descrambling sequence.

Optionally, the forming unit is specifically for determining a time-frequency resource location at which the random access request is received; and determining, based on the time-frequency resource location and the repeat rank, the random access radio network temporary identity of each terminal, wherein a different time-frequency resource location or a different repeat rank corresponds to a different random access radio network temporary identity.

Optionally, the acquiring unit is specifically for descrambling, based on the descrambling sequence, downlink control information; acquiring, based on the downlink control information, a reception parameter for the random access response data packet transmitted by the base station, wherein the reception parameter includes at least one of time-frequency resource and a modulation encoding strategy; and receiving, based on the reception parameter, the random access response data packet, and acquiring the random access response included in the random access response data packet.

Optionally, the downlink control information further includes a number of multiplexed terminals of the random access response data packet;

the acquiring unit is specifically for decoding, based on the multiplexed terminal number of the random access response data packet, the random access response data packet, to acquire the random access response.

Optionally, the acquiring unit is specifically for decoding, based on a packet length to which each multiplexed terminal number in a finite set T of the multiplexed terminal number and the descrambling sequence, and receiving the random access response data packet, respectively; when being decoded correctly, acquiring the random access response included in the random access response data packet transmitted by the base station.

Optionally, the third determining unit is specifically for carrying out a channel measurement, to form a channel measurement result; and determining, based on the channel measurement result, the repeat rank.

Optionally, the second transmitting is further for determining, based on the repeat rank, a transmission parameter of the random access request and/or random access information.

The information processing method, the base station, and the terminal in the embodiments of the present disclosure introduce the repeat rank to determine the transmission parameter for transmitting the random access response data packet. Different types of terminal or terminal in different application scenarios may have different repeat ranks, the repeat rank represents a current reception capability of the terminal with regard to signals transmitted by the base station, in this way, it is effectuated that the same transmission parameter is adopted to transmit the random access response data packet for those whose current reception capabilities are close, thus avoiding the problem of repeated reception of the terminal whose current reception capability is strong and poor reception quality of the terminal whose current reception capability is weak, due to that the transmission parameter for the random access response data packet of the terminal whose current reception capability is weak and the terminal whose current reception capability is strong. Accordingly, power consumption consumed by repeated reception of the terminal whose current reception capability is strong and communication resource wasted by repeatedly transmitting to the terminal whose current reception capability are reduced, and it is ensued that reception quality of the terminal whose current reception capability is weak is maintained at a relative high level.

### BRIEF DESCRIPTION OF THE DRAWINGS

FIG. 1 is a first schematic flowchart of the information processing method according to an embodiment of present disclosure;

FIG. 2 is a second schematic flowchart of the information processing method according to an embodiment of present disclosure;

FIG. 3 is a structural schematic diagram of the random access response data packet according to an embodiment of the present disclosure;

FIG. 4 is a third schematic flowchart of the information processing method according to an embodiment of present disclosure;

FIG. 5 is a fourth schematic flowchart of the information processing method according to an embodiment of present disclosure;

FIG. 6 is a fifth schematic flowchart of the information processing method according to an embodiment of present disclosure;

FIG. 7 is a structural schematic diagram of the base station according to an embodiment of the present disclosure; and

FIG. 8 is a structural schematic diagram of the first terminal according to an embodiment of the present disclosure.

### DETAILED DESCRIPTION OF THE EMBODIMENTS

Hereinafter, the embodiments of the present disclosure will be further described in detail with reference to the accompanying drawings.

### First Method Embodiment

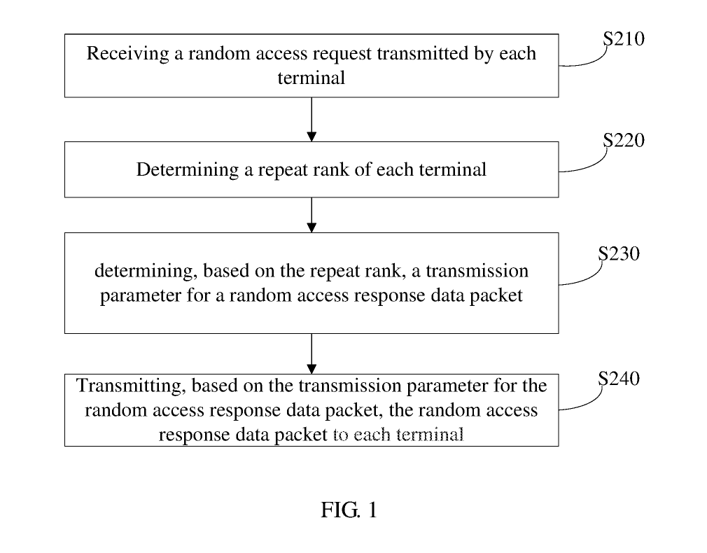

As shown in FIG. 1, this embodiment provides an information processing method applied to a base station, the method comprising:

step S210: receiving a random access request transmitted by each terminal;

step S220: determining a repeat rank of each terminal;

step S230: determining, based on the repeat rank, a transmission parameter for a random access response data packet; and

step S240: transmitting, based on the transmission parameter for the random access response data packet, the random access response data packet to each terminal.

The random access request usually carries a random access sequence for the terminal to request a random access to the base station, thereby communication may be made.

The concept of repeat rank of a terminal is introduced in this embodiment. Usually the repeat rank of a terminal may differ according to a type of the terminal, or differ according to a current application scenario. Specifically, for example, the MTC terminal and the ordinary terminal in the same application scenario may correspond to different repeat ranks. The repeat rank of the same type of terminal in different application scenarios may be different, such as one MTC terminal in a central area of a cell and another MTC terminal in an edge area of a cell may correspond to different repeat ranks due to the different application scenarios.

The transmission parameter determined in step S230 may include a packet length of the random access response data packet, the packet length is the number of bits included therein. The transmission parameter may further include the number of times that the random access response data packet is transmitted, and further a signal strength in which the random access response data packet is transmitted etc., the base station will transmit the random access response data packet based on the transmission parameter in step S240 after the transmission parameter is determined.

Obviously, because the concept of repeat rank is introduced to determine the transmission parameter for transmitting the random access response data packet in the information processing method in this embodiment of the present disclosure, the base station can set the transmission parameter for different types of terminal or terminal in different application scenarios. In this way, the terminal whose current reception capability is weak can receive the random access response data packet correctly, and also the terminal whose current reception capability is strong does not need to receive the random access response data packet repeatedly. Accordingly, the repeated transmission is reduced and resource utilization is improved while ensuring that the random access response data packet has a relative high rate of being correctly received, and the power consumption consumed by some terminal whose current reception capability is relatively strong is also reduced due to the reduction of operations like repeated reception.

### Second Method Embodiment

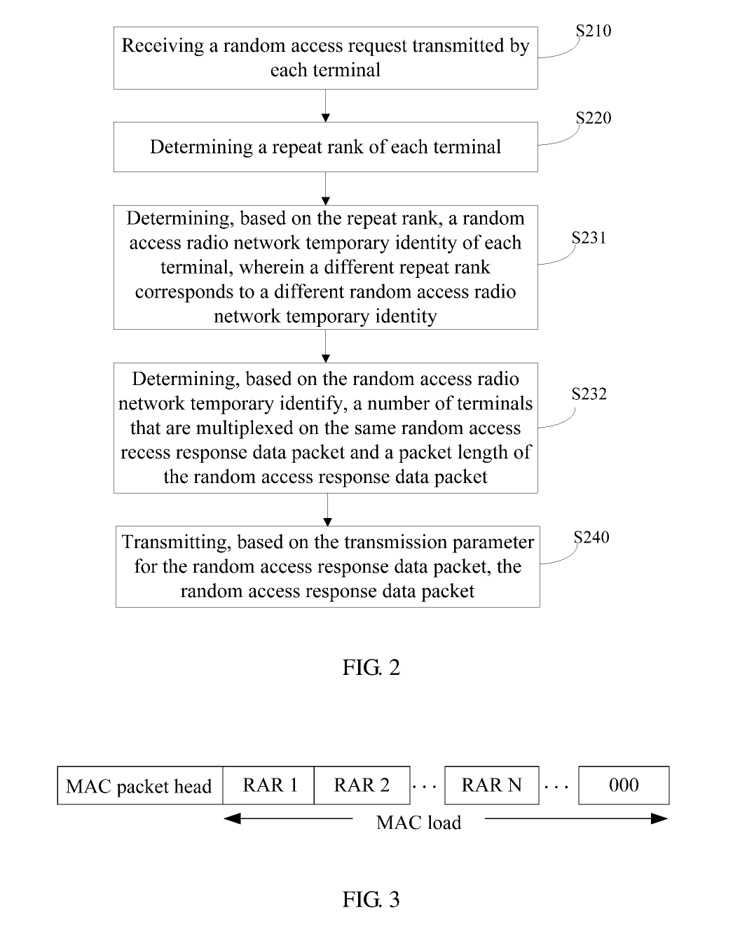

The step S230 as shown in FIG. 1, in this embodiment as shown in FIG. 2, may further comprise:

step S231: determining, based on the repeat rank, a random access radio network temporary identity of each terminal, wherein a different repeat rank corresponds to a different random access radio network temporary identity; and

step S232: determining, based on the random access radio network temporary identify, a number of terminals that are multiplexed on the same random access response data packet and a packet length of the random access response data packet.

Abbreviation of the random access radio network temporary identity is RA-RNTI.

RA-RNTI could be used to determine the packet length of the random access response data packet, when the base station forms the random access response data packet based on the packet length and transmits it to the terminal, the terminal also determines RA-RNTI based on its own repeat rank and finally decodes the random access response in a rapid way. RA-RNTI could be used to scramble the random access response data packet and/or control information of the random access response data packet etc.

The information processing method described in this embodiment is a further improvement based on the previous embodiment, obviously, in addition to differentiating transmission of the random access response data packet for different types of terminal and terminal in different application scenarios, it also has the advantage of easy implementation.

### Third Method Embodiment

Based on the second embodiment of the disclosure, in this embodiment, as shown in FIG. 2,

Step S231 may comprise:

determining a time-frequency resource location of the received random access request transmitted by each terminal; and

determining, based on the time-frequency resource location and the repeat rank, the random access radio network temporary identity of each terminal, wherein a different time-frequency resource location or a different repeat rank corresponds to a different random access radio network temporary identity.

In this embodiment, when determining the random access radio network temporary identity, it is not only based on the time-domain resource location transmitted in the random access request, but also it will introduce the repeat rank to determine. The time-domain resource location here may correspond to a time index of a time domain or a frequency index of a frequency domain.

Specifically, for example, the RA-RNTI of each terminal is determined based on formula RA-RNTI=A+B*t_id+C*f_id+D*k_id, wherein A, B, and C are all constants; t_id is a subframe number by which each terminal transmits the random access request; f_id is a frequency index by which each terminal transmits the random access request; k_id is the repeat rank; B may preferably take a value of a maximum not less than A; C may preferably take a value of a maximum not less than A+B*t_id; a minimum of C may preferably take a value of a maximum not less than A+B*t_id+C*f_id.

A communication scheme includes at least Time Division Multiplexing TDD and Frequency Division Multiplexing FDD. The following is a specific example of respective ones of A, B, C, and D when adopting the Time Division Multiplexing and Frequency Division Multiplexing,

RA-RNTI=1+t_id+10*k_id [FDD]

RA-RNTI=1+t_id+10*f_id+60*k_id [TDD]

wherein t_id may be the first subframe number (0≦t_id<10) where a random access PRACH of a random access sequence preamble transmitted by the terminal, f_id may be an index in the frequency domain of PRACH of the preamble transmitted in this subframe (0≦f_id<6). For FDD, f_id may be fixed as zero. k_id is the repeat rank to which the terminal corresponds. For example, in a long term evolution LTE system, the rank to which the terminal corresponds may be divided into four ranks, the value of the repeat rank may be in a range of 0≦k<4.

This embodiment provides in particular how to determine RA-RNTI based on the repeat rank. it also has the advantage of easy implementation, compatibility to regular implementation and also the advantages described in the first embodiment.

### Fourth Method Embodiment

Based on the second embodiment of the disclosure, in this embodiment,

Step S232 may comprise:

determining, based on the random access radio network temporary identity, a terminal number S of terminals that have the same random access radio network temporary identity, wherein terminals that have the same random access radio network temporary identity are multiplexed on the same random access response data packet, and determining, based on the terminal number S, the packet length of the random access response data packet.

Determining the packet length of the random access response data packet includes at least two manners.

First Manner:

the packet length of the random access response data packet is determined directly based on S, the packet length of the random access response data packet and S satisfy a certain function relationship. Specifically, for example, S equals to 6, then the packet length of the random access response data packet equals to F*6+a length of a data packet head; F is a bit number occupied by each random response.

Second Manner:

determining, based on the terminal number S, the packet length of the random access response data packet comprises:

comparing the terminal number S with a multiplexed terminal number in a finite set T of the multiplexed terminal number, forming a comparison result;

selecting, based on the comparison result, a packet length having a correspondence with a multiplexed terminal number M as the packet length of the random access response, wherein M is a multiplexed terminal number that is not less than S and has a minimum difference to S within T.

Usually, for the purpose of saving the number of random access response data packet and/or information amount transmitted by the base station, terminals with the same RA-RNTI will be multiplexed on the same random access response data packet. By the introduction of the repeat rank, different types of terminals or terminals in different application scenarios will be multiplexed on a different random access response data packet. So the problem that the MTC terminal has a poor reception quality and the ordinary terminal receives repeatedly is avoided, due to that the MTC terminal and the ordinary terminal share the same random access response data packet. This is also applied to terminals in different application scenarios.

However, in this embodiment, in order to facilitate the terminal sequentially decoding the random access response data packet, the finite set T of the multiplexed terminal number is also introduced, in this set, the multiplexed terminal number M of terminals that are multiplexed on the same random access response data packet is illustrated, and usually T is known to the terminal.

A specific example is provided below. It is assumed that the set T includes a limited number of multiplexing users, such as T={1, 3, 5, 7, 9}, terminals of the same RA-RNTI are divided into a group, its multiplexing terminal S is matched with a minimum element not less than S within T, in accordance with the terminal number that matches in T, the random access response is multiplexed into one random access response MAC data packet (RAR MAC PDU). For example, the multiplexed terminal number is 6, and matches with the element 7 in the set, then PDU is packaged in accordance with the packet length of multiplexing 7 terminals.

It is assumed that, each random access response RAR has a length of 48 bit, a data packet head length of the random access response is 8 bit, then when S equals to 6, the packet length of the corresponding random access response data packet is 344 bit.

If inter-terminal RAR multiplexing is not adopted, i.e., each random access response data packet has the random access response RAR of only one terminal, then the set T={1}.

If inter-terminal RAR multiplexing is adopted, the user number S is transmitted between eNB and terminals over a control channel, i.e., transmission of RAR is scheduled by a physical downlink control channel PDCCH, then the set T={S}. The manner described here corresponds to the second manner mentioned above.

If the inter-terminal RAR multiplexed terminal number N is not transmitted over the control channel, then the set T is defined as a finite set, and the maximum element in the set should be less than a multiplexed terminal number to which a maximum transmit block size of the random access response data packet corresponds.

This embodiment in particular provides several specific ways to determine the packet length of the random access response data packet based on S, which has the advantage of easy implementation and the both sides of the communication have the same implementation way to understand the relationship between the packet length and the number S.

If the second manner is adopted to determine the packet length of the random access response data packet, there may be a problem that S is less than the determined M, in this case, as a further improvement made to this embodiment, the method further comprises:

if S is less than M, writing designated information into (S+1)-th to M-th random access responses of the random access response data packet.

Here, the designated information may be all 0 or all 1 or a sequence formed by arranging 0 and 1 in a specified order etc. Specifically, for example, if the multiplexed terminal number N is less than the element that matches in the set T, then 0 is padded in the random access response data packet during multiplexing to reach a transmit block size to which the element that matches in T. If the multiplexed terminal number S is larger than a maximum element of the set T, then terminals RAR with amount of the maximum element in the set T are selected and multiplexed, and the other terminal access is discarded. In this way, when decoding said information, if the terminal decodes the designated information, it can be determined that the decoding is correct and the designated information is not a random access response.

FIG. 3 is an example of the random access response data packet, what is shown in FIG. 3 is that a protocol data unit MAC PDU that serves as the random response data packet includes a MAC header, and N random access responses RAR, and 0 padded after the N random access responses RAR into the rest bits as the designated information. The random access responses and the designated information 0 are carried in the random access response data packet as a MAC load.

### Fifth Method Embodiment

Based on the second embodiment of the disclosure, in this embodiment, step S220 may comprise:

determining, based on a transmission parameter of the random access request and/or random access information carried in the random access request, a repeat rank of each terminal.

The random access transmission parameter here may include a time-frequency source location at which the random access request is transmitted and the number of times that the random access request is transmitted and so on, the random access information includes the random access sequence and so on. When determining the repeat rank based on the random access sequence, usually the random access sequence and the repeat rank have a certain mapping relationship. The base station, such as eNB, receives the random access request, then determines the random access sequence, and thereafter determines the repeat rank based on the mapping relationship.

In addition, the terminal's own repeat rank could also be indicated through a specified information bit in the random access request. In this way, the base station may determine the repeat rank by decoding the random access request.

In a specific implementation, the base station may also determine the repeat rank based on a communication identification of the terminal. There are many ways to determine the repeat rank, not limited to the above examples.

To sum up, this embodiment provides several ways to determine the repeat rank of the terminal, which could be achieved by the random access request, identity of the terminal or other ways to simplify the implementation.

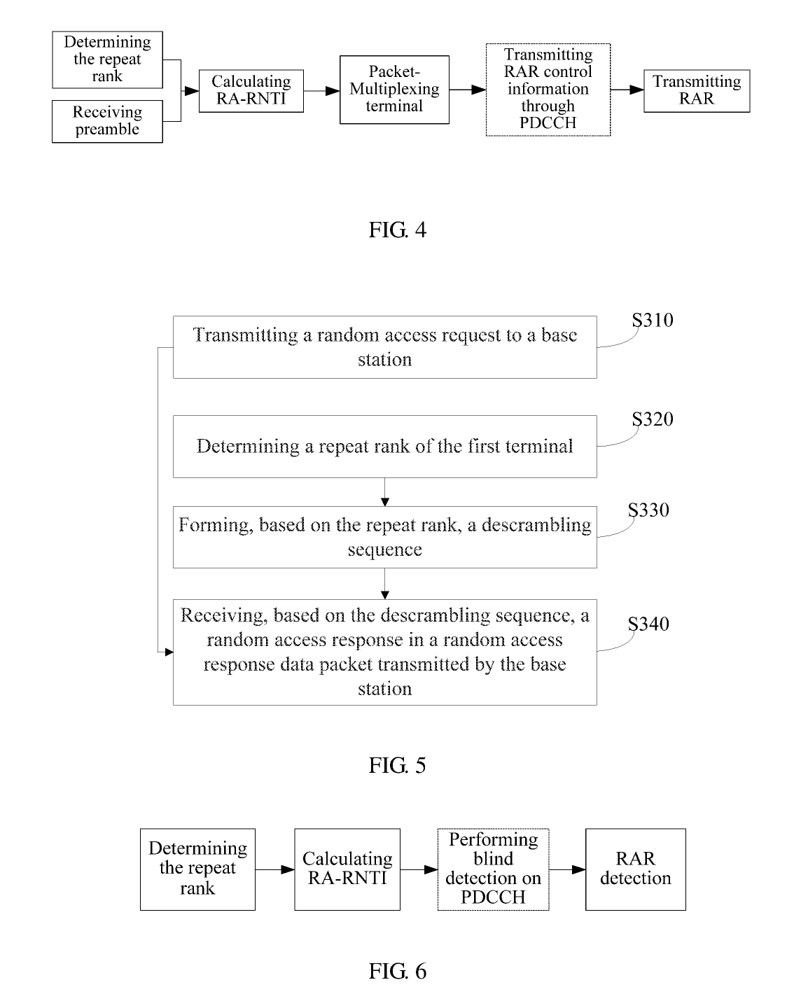

FIG. 4 is a specific example applied to the base station side in conjunction with the above method embodiment, the method in this example comprises:

The base station determines the repeat rank, receives preamble, which is the random access sequence; thereafter calculates RA-RNTI based on the received preamble and the repeat rank; and then terminals divided into a RA-RNTI group are multiplexed in the same random access response data packet. RAR control information is transmitted through PDCCH, which is the physical downlink control channel. RAR control information may include parameters such as time-domain resource of the random access response data packet, a modulation strategy, and a packet length of the random access response data packet etc. Last, the random access response RAR is transmitted.

In a specific implementation, one random access response data packet may include two or more RAR. The base station may notify each terminal of information like the time-domain resource where corresponding random access response resides through RAR control information, i.e., the preceding downlink control information.

### Sixth Method Embodiment

As shown in FIG. 5, this embodiment provides an information processing method applied to a first terminal, the method comprising:

step S310: transmitting a random access request to a base station;

step S320: determining a repeat rank of the first terminal;

step S330: forming, based on the repeat rank, a descrambling sequence; and

step S340: receiving, based on the descrambling sequence, a random access response in a random access response data packet transmitted by the base station,

wherein the random access response data packet includes at least one random access response.

The first terminal may be a communication device having a communication function, like various mobile phones, tablet computers etc. In step 310, a random access request is transmitted to the base station, to request a random access.

In an embodiment, step S320 and step S310 do not have a certain priority relationship, the repeat rank may be determined before or after transmitting the random access request. In another embodiment, the first terminal may first determine the repeat rank of the first terminal, thereafter transmit the random access request based on the determined repeat rank, i.e., step S320 is executed first, then step S310 is executed based on the obtained repeat rank. In this way, it is effectuated that the terminal may use a different random access sequence in the random access request based on a different repeat rank, correspondingly, the base station may also obtain the repeat rank of the terminal directly based on the received random access sequence.

In step S330, a descrambling sequence is determined based on the repeat rank, the descrambling sequence may be used to descramble information transmitted by the base station in the subsequent step S340, thus obtaining the random access response transmitted by the base station to the first terminal.

The information processing method described in this embodiment introduces the concept of repeat rank when acquiring the random access response, it corresponds to the method applied to the base station side as illustrated in the First Method Embodiment to the Fifth Method Embodiment, in this way, the communication system in entirety can achieve the aim of reducing communication resource overhead and power consumption of the terminal whose reception capability is high, while ensuring a correct reception rate of the random access response.

### Seventh Method Embodiment

Furthermore, step S330 may comprise:

determining, based on the repeat rank, a random access radio network temporary identity of the first terminal; and

forming, based on the random access radio network temporary identity, the descrambling sequence.

The preceding method embodiments describe the functions and effects of the random access radio network temporary identity RA-RNTI, the random access radio network temporary identity may be used as the descrambling sequence to descramble data scrambled by adopting RA-RNTI. Specifically, for example, the random access response data packet and/or control information of the random access response data packet and so on may be descrambled.

The method in this embodiment provides in particular how to determine descrambling sequence based on the repeat rank, on basis of the preceding embodiment, it also has the advantage of easy implementation.

### Eighth Method Embodiment

Furthermore, the step that determining, based on the repeat rank, a random access radio network temporary identity of the first terminal, comprises:

determining a time-frequency resource location at which the random access request is transmitted; and

determining, based on the time-frequency resource location and the repeat rank, the random access radio network temporary identity of each terminal, wherein a different time-frequency resource location or a different repeat rank corresponds to a different random access radio network temporary identity.

The repeat rank described in this embodiment is related to the time-domain resource location transmitted by the random access request, thus step S320 determines after determining the transmission parameter for the random access request, and definitely determines after transmitting the random access request.

The specific determining method may determine by adopting RA-RNTI=A+B*t_id+C*f_id+D*k_id. The Third Method Embodiment may be consulted for explanations of respective parameters in this formula, no more details repeated here.

The terminal can, on its own, simply determines RA-RNTI based on its own repeat rank and the time-frequency resource location at which the random access request is transmitted.

### Ninth Method Embodiment

As shown in FIG. 5, this embodiment provides an information processing method applied to a first terminal, the method comprising:

step S310: transmitting a random access request to a base station;

step S320: determining a repeat rank of the first terminal;

step S330: forming, based on the repeat rank, a descrambling sequence; and

step S340: receiving, based on the descrambling sequence, a random access response in a random access response data packet transmitted by the base station,

wherein the random access response data packet includes at least one random access response.

Step S330 may comprise:

determining, based on the repeat rank, a random access radio network temporary identity of the first terminal; and

forming, based on the random access radio network temporary identity, the descrambling sequence.

Step S340 may comprise:

descrambling, based on the descrambling sequence, downlink control information;

acquiring, based on the downlink control information, a reception parameter for the random access response data packet transmitted by the base station, wherein the reception parameter includes at least one of time-frequency resource and a modulation encoding strategy; and

receiving, based on the reception parameter, the random access response data packet, and acquiring the random access response included in the random access response data packet.

The downlink control information may include the physical downlink control information PDCCH transmitted by the base station. The downlink control information includes at least time-frequency resource and a modulation coding scheme; in this way, after receiving the downlink control information, the terminal will determine when to receive and from which frequency band to receive the random access response data packet based on the time-frequency resource in the transmission parameter, and also decode the received random access response data packet based on the modulation decoding scheme, thus acquiring the random access response carried in the random access response data packet for the first terminal.

In the information processing method in this embodiment, the base station adopts RA-RNTI to scramble the downlink control information of the random access response data packet, in this way, the base station will use RA-RNTI to descramble the downlink control information, thereby acquiring the random access response, it has the advantage of easy implementation and strong compatibility with the prior art.

### Tenth Method Embodiment

Step S330 may comprise:

determining, based on the repeat rank, a random access radio network temporary identity of the first terminal; and

forming, based on the random access radio network temporary identity, the descrambling sequence.

Step S340 may comprise:

descrambling, based on the descrambling sequence, downlink control information;

acquiring, based on the downlink control information, a reception parameter for the random access response data packet transmitted by the base station, wherein the reception parameter includes at least one of time-frequency resource and a modulation encoding strategy; and

receiving, based on the reception parameter, the random access response data packet, and acquiring the random access response included in the random access response data packet.

The downlink control information further includes a number of multiplexed terminals of the random access response data packet;

acquiring the random access response included in the random access response data packet comprises:

decoding, based on the multiplexed terminal number of the random access response data packet, the random access response data packet, to acquire the random access response.

In this embodiment, the downlink control information may further include a number S of terminals that are multiplexed on the same access recess response data packet, if the terminal knows S, it will know an original packet length of the random access response data packet, therefore, when decoding the random access response data packet sequentially, it is possible to decode simply and rapidly, thus having the advantage of easy implementation.

In a specific implementation, this embodiment adopts the finite set T of the multiplexed terminal number described in the preceding to determine the packet length of the random access response data packet, that is, S is no longer listed in the downlink control information, the base station determines, based on the finite set T of the multiplexed terminal number, a possible original packet length of the random access response data packet when receiving the random access response data packet, and tries decoding one time or multiple times based on the each possible original packet length, thus decoding and acquiring the random access response.

### Eleventh Method Embodiment

Step S330 may comprise:

determining, based on the repeat rank, a random access radio network temporary identity of the first terminal; and

forming, based on the random access radio network temporary identity, the descrambling sequence.

Step S340 may comprise:

decoding, based on a packet length to which each multiplexed terminal number in a finite set T of the multiplexed terminal number and the descrambling sequence, and receiving the random access response data packet, respectively;

when being decoded correctly, acquiring the random access response included in the random access response data packet transmitted by the base station.

As for the description related to the finite set T of the multiplexed terminal number, the preceding method embodiments applied to the base station side can be consulted, no more details repeated here. To sum up, the first terminal foreknows the finite set T of the multiplexed terminal number, so that it can know a possible packet length value of the received random access response data packet, in this way, in combination with the scrambling sequence, it is possible to decode the random access response data packet at least one time, thus acquiring the random access response data packet transmitted by the base station to the first terminal.

Accordingly, the method described in this embodiment does not need the base station to transmit the downlink control information to indicate the number S of the multiplexed terminal, information amount of interaction between the base station and the terminal can be reduced, power consumption of the terminal consumed by receiving the transmitted information can be lowered.

In a specific implementation, the random access response data packet may be scrambled with other scrambling sequences, so that the terminal does not RA-RNTI when descrambling the random access response data packet, however, if the base station adopt RA-RNTI to scramble, then the terminal adopts the same to descramble, which can reduce using of the scrambling and descrambling sequences, and save sequence resource.

### Twelfth Method Embodiment

Step S320 may comprise:

carrying out a channel measurement, to form a channel measurement result; and

determining, based on the channel measurement result, the repeat rank.

The repeat rank may be set statically within the terminal and/or the base station, and may also be set dynamically. When the terminal is in a different communication scenario, its capability of receiving signals transmitted by the base station is different, in order to ensure that the terminal can always correctly receive and decode the random access response, a manner of dynamically determining is adopted in this embodiment to determine the repeat rank.

Accordingly, in this embodiment, the first terminal will perform a channel measurement, for example, performing a channel measurement based on a transmission signal like a discovery signal transmitted by the base station, and form a channel measurement result. The channel measurement result may represent a channel quality of communication made between the first terminal and the base station currently, thus reflecting the first terminal's reception capability for the signals transmitted by the base station. In this case, the first terminal then dynamically determines the repeat rank, and the transmission parameter for the random access response data packet determined based on such repeat rank can ensure a correct reception rate of the first terminal.

### Thirteenth Method Embodiment

Step S310 may comprise:

determining, based on the repeat rank, a transmission parameter of the random access request and/or random access information.

In this embodiment, the repeat rank has certain correspondence with the transmission parameter of the random access request and the random access information, for example, the repeat rank is determined based on the channel measurement result, and the transmission parameter of the random access request is determined based on the repeat rank, in this way, after receiving the random access request, the base station will determine the repeat rank of the first terminal based on the transmission parameter of the random access request and/or information content of the random access information, thus effectuating the manner of notifying the base station of the repeat rank of the first terminal, in this way, it can facilitate the base station acquiring the repeat rank of the first terminal, and simplifying operations of the base station.

Based on the preceding information processing method applied to the first terminal side as shown in FIG. 6, a specific example is provided, in this example, the first terminal will determine its own repeat rank, calculate RA-RNTI based on the repeat rank, perform a blind detection on PDCCH based on RA-RATI, and finally detect RAR based on the detection result with regard to PDCCH. PDCCH is for notifying the modulation coding scheme of the first terminal and the time-frequency resource at which the random access response data packet is transmitted, and finally RAR can be detected based on S or T notified by PDCCH.

### First Device Embodiment

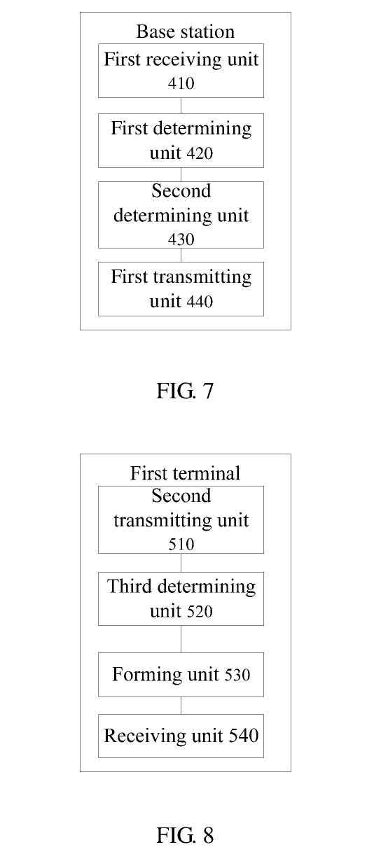

As shown in FIG. 7, this embodiment provides a base station, comprising:

a first receiving unit 410 for receiving a random access request transmitted by each terminal;

a first determining unit 420 for determining a repeat rank of each terminal;

a second determining unit 430 for determining, based on the repeat rank, a transmission parameter for a random access response data packet to each terminal; and

a first transmitting unit 440 for transmitting, based on the transmission parameter for the random access response data packet, the random access response data packet to each terminal.

The first receiving unit 410 and the first transmitting unit 440 in this embodiment may both correspond to an air interface by which the base station and the terminal communicatively interface, such as X2 interface, the specific hardware structure may include a transceiving antenna etc.

The first determining unit 420 and the second determining unit 430 may correspond to a processor or a processing chip having an information processing capability within the base station. The processor or the processing chip achieves the functions of the first determining unit 420 and the second determining unit 430 through executing specified codes. The processor may be a central process CPU, a microprocessor MCU, a digital signal processor DSP, or a programmable array PLC, and other structures.

As for descriptions related to the repeat rank and the transmission parameter and so on in this embodiment, the method embodiments may be consulted, no more details repeated here.

To sum up, when the base station described in this embodiment is used to transmit the random access response data packet, a correct reception rate of each terminal can be ensured, meanwhile overhead of resource consumption and power consumption of some terminal whose reception capability is high are reduced.

The repeat rank described in this embodiment can be used to reflect the terminal's current reception capability for the signals transmitted by the base station, for example, different types of terminal may have inconsistent reception capability, and the repeat rank may be different. The base station may be an evolution-type base station, like eNB etc.

### Second Device Embodiment

The second determining unit 430 comprises:

a first determining module for determining, based on the repeat rank, a random access radio network temporary identity of each terminal, wherein a different repeat rank corresponds to a different random access radio network temporary identity, and

a second determining module for determining, based on the random access radio network temporary identify, a number of terminals that are multiplexed on the same random access recess response data packet and a packet length of the random access response data packet.

The second determining unit 430 in this embodiment is divided into two portions, one portion for determining RA-RNTI, the other portion for determining the packet length of the random access response data packet. The two portions may correspond to different processors having the information processing function, and may also be integrated to correspond to a single processor, but codes used by the processor, to which the two portion are integrated to correspond, to implement the two determining modules are not consistent.

The first determining module may further correspond to structures like a computer or a processor having a computing function and so on.

Based on the base station in the preceding embodiment, the base station in this embodiment further defines the specific structure of the second determining module 430, and has the advantage of simple structure, and can be used to implement the information processing method described in the Second Method embodiment.

### Third Device Embodiment

The second determining unit 430 comprises:

a first determining module for determining, based on the repeat rank, a random access radio network temporary identity of each terminal, wherein a different repeat rank corresponds to a different random access radio network temporary identity; and

a second determining module for determining, based on the random access radio network temporary identify, a number of terminals that are multiplexed on the same access recess response data packet and a packet length of the random access response data packet.

The first determining module is specifically for determining a time-frequency resource location of the received random access request transmitted by each terminal; and determining, based on the time-frequency resource location and the repeat rank, the random access radio network temporary identity of each terminal, wherein a different time-frequency resource location or a different repeat rank corresponds to a different random access radio network temporary identity.

This embodiment defines in particular the specific structure of the first determining module, the formula mentioned in the preceding method embodiment may be adopted to calculate RA-RNTI, accordingly, the specific structure of the first determining module may be a computer or a processor having a computing function.

To sum up, the base station described in this embodiment may be a hardware structure that implements the information processing method in the preceding Third Method Embodiment, and it has the advantage of simple structure and easy implementation, compatibility to regular implementation and also the advantages described in the first embodiment.

### Fourth Device Embodiment

The second determining unit 430 comprises:

a first determining module for determining, based on the repeat rank, a random access radio network temporary identity of each terminal, wherein a different repeat rank corresponds to a different random access radio network temporary identity; and

a second determining module for determining, based on the random access radio network temporary identify, a number of terminals that are multiplexed on the same access recess response data packet and a packet length of the random access response data packet.

The second determining module is specifically for determining, based on the random access radio network temporary identity, a terminal number S of terminals that have the same random access radio network temporary identity, wherein terminals that have the same random access radio network temporary identity are multiplexed on the same random access response data packet; and determining, based on the terminal number S, the packet length of the random access response data packet.

The second determining module in this embodiment is specifically for determining the number S of terminals that are multiplexed on the same random access response data packet based on RA-RNTI, and determining the packet length of the random access response data packet based on S.

There are various structures of the second determining module, including at least the following two:

First structure: the second determining module is specifically for comparing the terminal number S with a are multiplexed terminal number in a finite set T of the are multiplexed terminal number, forming a comparison result; and selecting, based on the comparison result, a packet length having a correspondence with a are multiplexed terminal number M as the packet length of the random access response data packet, wherein M is a are multiplexed terminal number that is not less than S and has a minimum difference with S within T.

Second structure: the second determining module directly determines the packet length of the random access response data packet based on a functional relationship between S and the packet length, without using T in this case.

This embodiment first provides two structures for the second determining module to determine the packet length of the random access response data packet, it has the advantage of simple structure and easy implementation and the both sides of the communication have the same implementation way to understand the relationship between the packet length and the number S.

As a further improvement to the base station in this embodiment, the base station further comprise:

a writing unit for, if S is less than M, writing designated information into (S+1)-th to M-th random access responses of the random access response data packet.

The writing unit may be used for forming the random access response data packet, in this embodiment, if S is less than M, designated information will be written into (S+1)-th to M-th random access responses of the random access response data packet. The designated information may be a sequence of all 0 or a sequence of all 1 or a sequence formed by arranging 0 and 1 in a specified order etc.

The base station described in this embodiment may be a structure that implements the information processing method in the Fourth Method embodiment, and is also capable of ensuring a correct reception rate of the random access response of each terminal, and reducing resource consumption and power consumption of the terminal for the communication system in entirety.

### Fifth Device Embodiment

The first determining unit 420, which is specifically for determining, based on a transmission parameter of the random access request and/or random access information carried in the random access request, a repeat rank of each terminal.

The repeat rank may be set statically, so that the first determining unit 420 may acquire the repeat rank by querying a database that stores the repeat rank of each terminal, and it is also possible to determine the repeat rank based on one of or a combination of the transmission parameter of the random access request or the random access information. No matter which manner is adopted by the first determining unit 420, the corresponding structure of the first determining unit 420 is different, the first determining unit 420 may comprise a processor having a query function or having the function of determining the repeat rank based on the transmission parameter of the random access request or random access information.

To sum up, this embodiment provides a specific structure of the first determining unit 420, which may be used to provide hardware for implementing the information processing method described in the Fifth Method Embodiment, and it has the advantage of simple structure and easy implementation.

### Sixth Device Embodiment

As shown in FIG. 8, this embodiment provides a which is a first terminal comprising:

a second transmitting unit 510 for transmitting a random access request to a base station;

a third determining unit 520 for determining a repeat rank of the first terminal; a forming unit 530 for forming, based on the repeat rank, a descrambling sequence; and

an receiving unit 540 for receiving, based on the descrambling sequence, a random access response in a random access response data packet transmitted by the base station,

wherein the random access response data packet includes at least one random access response.

The first terminal in this embodiment may be any type of communication terminal that can communicate with the base station, such as mobile phone, tablet computer etc.

The second transmitting unit 510 may be a structure like transmitting antenna and so on within the first terminal, and can transmit signals to the base station.

The specific structures of the second determining unit 520, the forming unit 530, and the acquiring unit 540 may include various processors having the information processing function as included within the first terminal, such as application processor AP, central processor CPU, micro processor MCU, digital signal processor DSP, or programmable array PLC, and other structures.

The terminal provided in this embodiments provides hardware for implementing the information processing method as described in the Sixth Method Embodiment, and also it can achieve the aim of reducing communication resource overhead and power consumption of the terminal whose reception capability is high, while ensuring a correct reception rate of the random access response.

### Seventh Device Embodiment

The forming unit 530 is specifically for determining, based on the repeat rank, a random access radio network temporary identity of the first terminal; and forming, based on the random access radio network temporary identity, the descrambling sequence.

The specific structure of the forming unit 530 described in this embodiment may include a processor or a computing structure like a processing chip having an information processing capability, and can be used to calculate RA-RNTI based on the repeat rank and the functional relationship for calculating RA-RNTI as mentioned in the preceding method embodiment.

The first terminal in this embodiment is a further improvement made based on the preceding device embodiment, it embodies the structure of the forming unit, and has the advantage of simple structure and easy implementation.

### Eighth Device Embodiment

Furthermore, the forming unit 530 is specifically for determining, based on the repeat rank, a random access radio network temporary identity of the first terminal, and forming, based on the random access radio network temporary identity, the descrambling sequence.

The forming unit 530 is specifically for determining a time-frequency resource location at which the random access request is transmitted; and determining, based on the time-frequency resource location and the repeat rank, the random access radio network temporary identity of each terminal, wherein a different time-frequency resource location or a different repeat rank corresponds to a different random access radio network temporary identity.

Based on the preceding device embodiment, this embodiment lists in detail input parameters that the forming unit 530 will consider when determining RA-RNTI, as for specific meanings of these parameter, the preceding method embodiment may be consulted, no more detail repeated here. To sum up, the first terminal in this embodiment can be used to implement the information processing method as described in the Eighth Method Embodiment.

### Ninth Device Embodiment

The acquiring unit 510 is specifically for descrambling, based on the descrambling sequence, downlink control information; acquiring, based on the downlink control information, a reception parameter for the random access response data packet transmitted by the base station, wherein the reception parameter includes at least one of time-frequency resource and a modulation encoding strategy; and receiving, based on the reception parameter, the random access response data packet, and acquiring the random access response included in the random access response data packet.

The specific structure of the acquiring unit 510 may include processing chip structures having an information parsing function like a parser, in this embodiment, the acquiring unit 510 first uses the descrambling sequence to descramble the downlink control information and obtain a reception parameter, and then receives the random access response data packet based on the reception parameter and acquires the random access response.

The first terminal in this embodiment may be implemented as hardware for implementing the information processing method described in the Ninth Method Embodiment, it can achieve the aim that repeated transmission is reduced and resource utilization is improved while ensuring that the random access response data packet has a relative high rate of being correctly received, and the power consumption consumed by some terminal whose current reception capability is relatively strong due to operations like repeated reception is reduced, and it also has the advantage of simple structure.

### Tenth Device Embodiment

The acquiring unit 510 is specifically for descrambling, based on the descrambling sequence, downlink control information; acquiring, based on the downlink control information, a reception parameter for the random access response data packet transmitted by the base station, wherein the reception parameter includes at least one of time-frequency resource and a modulation encoding strategy; and receiving, based on the reception parameter, the random access response data packet, and acquiring the random access response included in the random access response data packet.

The downlink control information further includes a number of multiplexing terminals of the random access response data packet;

the acquiring unit 510 is specifically for decoding, based on the multiplexed terminal number of the random access response data packet, the random access response data packet, to acquire the random access response.

The downlink control information further includes the multiplexed terminal number S, so that it facilitates the acquiring unit decoding the random access response data packet. In this way, the acquiring unit 510 will decode the random access response data packet based on S, and thereby obtain the random access response transmitted by the base station to the first terminal in a rapid way.

The first terminal in this embodiment may be implemented as hardware for implementing the information processing method described in the Tenth Method Embodiment, it can achieve the aim that repeated transmission is reduced and resource utilization is improved while ensuring that the random access response data packet has a relative high rate of being correctly received, and the power consumption consumed by some terminal whose current reception capability is relatively strong due to operations like repeated reception is reduced, and it also has the advantage of simple structure.

### Eleventh Device Embodiment

The acquiring unit 510 is specifically for decoding, based on a packet length to which each multiplexed terminal number in a finite set T of the multiplexed terminal number and the descrambling sequence, and receiving the random access response data packet, respectively; when being decoded correctly, acquiring the random access response included in the random access response data packet transmitted by the base station.

In this embodiment, the acquiring unit 510 determines a possible packet length of the random access response data packet based on the multiplexed terminal number to which T corresponds, the random access response transmitted by the base station to the first terminal can be obtained by decoding possibly one time or multiple times, this is another structure for implementing the information processing method described in the preceding embodiment

### Twelfth Device Embodiment

The third determining unit 520 is specifically for carrying out a channel measurement, to form a channel measurement result; and determining, based on the channel measurement result, the repeat rank.

The repeat rank may be set statically or dynamically. In this embodiment, the repeat rank is determined dynamically. The third determining unit 520 includes structures that can perform a channel measurement like receiving antenna and so on, and then calculates information like the reception signal strength and so on through the measurement result, and thereby determines the repeat rank. The first terminal in this embodiment may correspond to a different repeat rank in a different application scenario, in this way, in a different scenario of the first terminal, the transmission parameter that the base station transmits the access random response data packet may be different, the reception quality that the first terminal receives the random access response data packet may be maintained at a better level. To sum up, the first terminal in this embodiment may used to provide hardware for the Twelfth Method Embodiment.

### Thirteenth Device Embodiment

The second transmitting 510 is further for determining, based on the repeat rank, a transmission parameter of the random access request and/or random access information.

The specific structure of the second transmitting unit 510 in this embodiment may include an information processor for determining the transmission parameter and/or the random access information, besides a transmission interface, these structures can be used for information processing. If the first terminal adopts the structure in this embodiment, after receiving the random access request, the base station directly determines the repeat rank of the first terminal based on the transmission parameter of the random access request and/or the random access information.

In the several embodiments provided by the present disclosure, it should be understood that the device/apparatus and methods disclosed therein may also be implemented by other manners. The above described device/apparatus embodiments are merely illustrative, for example, the unit division is only a logical function division, there may be other division manners in practical implementation, such as: a plurality of units or components may be combined or may be integrated into another system, or some features may be omitted or not executed. In addition, coupling, or direct coupling, or communicative connection between the shown or discussed respective components may be achieved through some interfaces, indirect coupling or communicative connection between devices or units may be electrical, mechanical, or other forms.

Units described above as separate members may be or may not be physically separated, components showed as units may be or may not be physical units; they may be located at one place or distributed to a plurality of network cells; it is possible to select some or all of the units therein to achieve the purpose of solutions in the embodiments according to the actual needs.

Further, respective functional units in the embodiments of the present disclosure may be all integrated in one processing unit and may also be separated as one unit each, or two or more units may also be integrated in one unit; the aforesaid integrated unit may be implemented in the form of hardware or in the form of hardware plus software functional unit.

As will be appreciated by those of ordinary skill in the art: all or part of the steps of the above method embodiments may be completed by instructing relevant hardware through programs, these programs may be stored in a computer readable storage medium, the steps included in the above method embodiments will be executed when the programs are executed, the aforesaid storage medium includes various mediums capable of storing program codes like a mobile storage device, a Read Only Memory (ROM), a magnetic disk, or an optical disk.

Alternatively, the above integrated units of the present disclosure may also be stored in a computer readable storage medium when being implemented in the form of a software functional module and sold and used as an independent product. Based on such understanding, the substance or the part that contributes to the prior art of the technical solutions of embodiments of the present disclosure may be reflected in the form of a software product, the computer software product may be stored in a storage medium, and include several instructions for causing a computer apparatus (which may be a personal computer, a server, or a network device) to fully or partially perform the method described in the various embodiments of the present disclosure. The aforesaid storage medium includes various mediums capable of storing program codes like a mobile storage device, a Read Only Memory (ROM), a magnetic disk, or an optical disk.

The above described are merely specific implementations of the present disclosure, however, the protection scope of the present disclosure is limited thereto, modifications or replacements that are easily conceivable for those skilled in the art within the technique range disclosed in the present disclosure should all fall into the protection scope of the present disclosure. Therefore, the protection scope of the present disclosure should be based on what is claimed in the claims.

What is claimed is:

1. An information processing method, comprising:
receiving a random access request transmitted by a terminal;
based on a repeat rank related to the terminal, achieve a transmission parameter for transmitting a random access response data packet to the terminal; and
transmitting, based on the transmission parameter for the random access response data packet, the random access response data packet.

2. The method according to claim 1, wherein;
based on a repeat rank related to the terminal, achieve a transmission parameter for transmitting a random access response data packet to the terminal comprises:
achieving, based on the repeat rank, a random access radio network temporary identity of the terminal, wherein a different repeat rank corresponds to a different random access radio network temporary identity; and
achieving, based on the random access radio network temporary identify, a number of terminals that are multiplexed on the same random access response data packet and a packet length of the random access response data packet.

3. The method according to claim 2, wherein:
achieving, based on the repeat rank, a random access radio network temporary identity of the terminal comprises:
achieving a time-frequency resource location of the received random access request transmitted by the terminal, and
determining, based on the time-frequency resource location and the repeat rank, the random access radio network temporary identity of each terminal, wherein a different time-frequency resource location or a different repeat rank corresponds to a different random access radio network temporary identity.

4. The method according to claim 2, wherein:
achieving, based on the random access radio network temporary identify, a number of terminals that are multiplexed on the same random access recess response data packet and a packet length of the random access response data packet comprises:
determining, based on the random access radio network temporary identity, a terminal number S of terminals that have the same random access radio network temporary identity, wherein terminals that have the same random access radio network temporary identity are multiplexed on the same random access response data packet; and
determining, based on the terminal number S, the packet length of the random access response data packet.

5. The method according to claim 4, wherein:
determining, based on the terminal number S, the packet length of the random access response data packet comprises:
comparing the terminal number S with a multiplexed terminal number in a finite set T of the multiplexed terminal number, forming a comparison result;
selecting, based on the comparison result, a packet length having a correspondence with a multiplexed terminal number M as the packet length of the random access response, wherein M is a multiplexed terminal number that is not less than S and has a minimum difference with S within T.

6. The method according to claim 5, wherein:
the method further comprises:
if S is less than M, writing designated information into (S+1)-th to M-th random access responses of the random access response data packet.

7. The method according to claim 1, wherein:
determining a repeat rank of each terminal comprises:
determining, based on a transmission parameter of the random access request and/or random access information carried in the random access request, a repeat rank of each terminal.

8. An information processing method, comprising:
transmitting a random access request to a base station;
acquiring, based on the descrambling sequence formed by a repeat rank, a random access response in a random access response data packet transmitted by the base station,
wherein the random access response data packet includes at least one random access response.

9. The method according to claim 8, wherein;
acquiring, based on the descrambling sequence formed by a repeat rank, a random access response in a random access response data packet transmitted by the base station comprises:
acquiring, based on the repeat rank, a random access radio network temporary identity of the first terminal; and
forming, based on the random access radio network temporary identity, the descrambling sequence.

10. The method according to claim 9, wherein:
acquiring, based on the repeat rank, a random access radio network temporary identity of the first terminal comprises:
acquiring a time-frequency resource location at which the random access request is transmitted; and
determining, based on the time-frequency resource location and the repeat rank, the random access radio network temporary identity of each terminal, wherein a different time-frequency resource location or a different repeat rank corresponds to a different random access radio network temporary identity.

11. The method according to claim 8, wherein:
acquiring, based on the descrambling sequence, a random access response in a random access response data packet transmitted by the base station based on the random access request comprises:
descrambling, based on the descrambling sequence, downlink control information;
acquiring, based on the downlink control information, a reception parameter for the random access response data packet transmitted by the base station, wherein the reception parameter includes at least one of time-frequency resource and a modulation encoding strategy; and
receiving, based on the reception parameter, the random access response data packet, and acquiring the random access response included in the random access response data packet.

12. The method according to claim 11, wherein:
the downlink control information further includes a number of multiplexing terminals of the random access response data packet;
acquiring the random access response included in the random access response data packet comprises:
decoding, based on the multiplexed terminal number of the random access response data packet, the random access response data packet, to acquire the random access response.

13. The method according to claim 8, wherein:
acquiring, based on the descrambling sequence, a random access response in a random access response data packet transmitted by the base station based on the random access request comprises:
decoding, based on a packet length to which each multiplexed terminal number in a finite set T of the are multiplexed terminal number and the descrambling sequence, and receiving the random access response data packet, respectively;
when being decoded correctly, acquiring the random access response included in the random access response data packet transmitted by the base station.

14. The method according to claim 8, wherein:
determining a repeat rank of the first terminal comprises:
carrying out a channel measurement, to form a channel measurement result; and
determining, based on the channel measurement result, the repeat rank.

15. The method according to claim 8, wherein:
transmitting, by the first terminal, a random access request to a base station comprises:
determining, based on the repeat rank, a transmission parameter of the random access request and/or random access information.

16. A base station, comprising:
a first receiving unit for receiving a random access request transmitted by a terminal;
an achieving determining unit for based on a repeat rank related to the terminal, achieve a transmission parameter for transmitting a random access response data packet to the terminal; and
a first transmitting unit for transmitting, based on the transmission parameter for the random access response data packet, the random access response data packet.

17. The base station according to claim 16, wherein:
the second achieving unit comprises:
a first achieving module for determining, based on the repeat rank, a random access radio network temporary identity of each terminal, wherein a different repeat rank corresponds to a different random access radio network temporary identity; and
a second achieving module for determining, based on the random access radio network temporary identify, a number of terminals that are multiplexed on the same random access recess response data packet and a packet length of the random access response data packet.

18. The base station according to claim 17, wherein:
the first achieving module is specifically for achieving a time-frequency resource location of the received random access request transmitted by the terminal; and determining, based on the time-frequency resource location and the repeat rank, the random access radio network temporary identity of the terminal, wherein a different time-frequency resource location or a different repeat rank corresponds to a different random access radio network temporary identity.

19. The base station according to claim 17, wherein:
the second achieving module is specifically for determining, based on the random access radio network temporary identity, a terminal number S of terminals that have the same random access radio network temporary identity, wherein terminals that have the same random access radio network temporary identity are multiplexed on the same random access response data packet; and determining, based on the terminal number S, the packet length of the random access response data packet.

20. The base station according to claim 19, wherein:
the second determining module is specifically for comparing the terminal number S with a multiplexed terminal number in a finite set T of the multiplexed terminal number, forming a comparison result; and selecting, based on the comparison result, a packet length having a correspondence with a multiplexed terminal number M as the packet length of the random access response, wherein M is a multiplexed terminal number that is not less than S and has a minimum difference with S within T.
